(19) United States
(12) Patent Application Publication
(10) Pub. No.: US 2004/0263473 A1
(43) Pub. Date: Dec. 30, 2004

(54) Wearable finger montion sensor for sensing finger motion and method of sensing finger motion using the same

(75) Inventors: Joon-kee Cho, Gyeonggi-do (KR); Sang-goog Lee, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/876,526

(22) Filed: Jun. 28, 2004

(30) Foreign Application Priority Data
Jun. 28, 2003 (KR) 2003-42938

(51) Int. Cl. G09G 5/00

(52) U.S. Cl. 345/156

(57) ABSTRACT

A wearable finger motion sensor and a method of sensing using the same is provided. The wearable finger motion sensor includes finger rings having a predetermined recognition pattern on each ring, and a bracelet having a photographing tool for taking picture of the fingers, a device for recognizing movement of a finger from analyzing the photographed images, and a device for abstracting data corresponding to a moved finger.

This application claims priority from Korean Patent Application No. 2003-42938, filed on Jun. 28, 2003, in the Korean Intellectual Property Office, the disclosure of which is incorporated herein in its entirety by reference.

### BACKGROUND OF THE INVENTION

1. Field of the Invention

The present invention relates to a motion sensor for a moving body and a method of sensing the moving body, and more particularly, to a wearable finger motion sensor for data input and a method of sensing finger motion.

2. Description of the Related Art

Keyboards are widely used for inputting data into a computer and can be replaced by touch pads according to how the computer is to be used, such as for depositing and withdrawing cash.

As the size of computers decrease, wearable data input devices capable of realizing all functions of the keyboard using a pseudo keypad have been drawing interest. Generally, the wearable data input device using a pseudo keypad inputs data by means of sensing finger motion.

A conventional wearable finger motion sensor (hereinafter, conventional sensor) senses the motion of a finger using a ring-type finger motion sensor with a built-in sensor on the finger. The conventional sensor comprises a signal processing section for processing an output signal from the built-in sensor and a signal transmitting wire for transmitting a signal from the built-in sensor to the signal process section disposed between the built-in sensor and the signal process section. Drawbacks of the conventional sensor are the inconvenience in attaching and removing the sensor from the finger and discomfort from long hours of usage.

A wireless wearing sensor for sensing the finger motion has been introduced. However, size reduction and low power consumption has not been achieved due to structural limitations of the device, that is, all devices including the wireless transmitter have to be worn on the finger. Moreover, the configuration of the devices become further complicated when a battery and an antenna are included.

### SUMMARY OF THE INVENTION

Illustrative, non-limiting embodiments of the present invention overcome the above disadvantages and other disadvantages not described above.

An apparatus consistent with the present invention provides a wearable sensor for sensing finger motion, the sensor being easily worn and removed from the fingers, comfortable, and being configurable into a simple device by miniaturization and low power consumption.

A method consistent with the present invention also provides a process of sensing finger motion using the wearable finger motion sensor.

According to an aspect of the present invention, a wearable finger motion sensor includes a ring on which a predetermined recognition pattern is formed and is to be worn on each finger, a bracelet in which a photographing tool for taking pictures of a finger on which a ring is worn, and an image processing section for recognizing movement of a finger by analyzing the photographed images and abstracting data corresponding to the moved finger.

The bracelet further includes a wireless communication module having an antenna, built in or external, for transmitting data that is abstracted from the bracelet.

The bracelet also has first and second infrared light emission devices disposed on both sides of the photographing tool for emitting infrared light toward the rings.

The photographing tool for taking pictures of fingers is a wide angle mini camera capable of taking pictures of the five fingers at the same time. An infrared light filter can be disposed on a front face of the photographing tool.

Each recognition pattern has a different shape of an embossed or an engraved pattern formed on a face of each ring facing the bracelet, or each recognition pattern is a formative statue having a predetermined different shape from each finger. The formative statue can be an infrared light reflection mirror.

The infrared light reflection mirror is disposed on an upper surface of the face of the ring.

According to another aspect of the present invention, a method of sensing finger motion includes taking pictures of fingers wearing the rings on which a predetermined recognition pattern is formed, abstracting a characteristic of the recognition pattern of each of the rings worn on each finger through an analysis of finger images that are taken, and identifying a moved finger based on the abstracted characteristics.

The method can further include transmitting data corresponding to the moved finger to an external device.

Pictures of the fingers can be taken while the infrared light is irradiated to the rings.

The action of abstracting a characteristic of a recognition pattern of a ring worn on a finger through an analysis of photographs taken of a finger further comprises obtaining a binary scale image including the bright spot of the finger image by irradiating an infrared light, identifying the bright spot using an image filter in which information on the size and shape of the bright spot are programmed, obtaining the location of the identified bright spot.

The wearable finger motion sensor for sensing finger motion according to the present invention is easy to wear and to remove. Comfort when wearing the device can be maintained throughout the whole time of use. Because the system can employ a small battery and a built-in antenna, the configuration of the system can be simplified and miniaturized.

### BRIEF DESCRIPTION OF THE DRAWINGS

The features and advantages of the present invention will become more apparent by describing in detail exemplary embodiments thereof with reference to the following drawings in which like reference numerals refer to like elements, and wherein:

FIG. 1 is a perspective view of a right hand wearing a wearable finger motion sensor for sensing finger motions, according to a first embodiment of the present invention;

FIG. 2 is a magnified perspective view of a wearable finger motion sensor depicted in FIG. 1;

FIGS. 3A through 3E are partial perspective views of a wearable finger motion sensor showing a variety of patterns that can be formed on the pattern forming region;

FIG. 4 is a front face of a type of wearable finger motion sensor different from the type depicted in FIG. 1;

FIG. 5 is a perspective view of a right hand wearing a wearable finger motion sensor for sensing finger motions, according to a second embodiment of the present invention;

FIG. 6 is a magnified perspective view of a wearable finger motion sensor depicted in FIG. 5;

FIGS. 7A through 7C are front views for showing a variety of infrared reflection devices equipped on a ring;

FIGS. 8 through 11 are photographed images for showing demonstrations of operating a wearable finger motion sensor according to the present invention; and

FIG. 12 is flow chart for showing a method of sensing finger motions using a wearable finger motion sensor according to the present invention.

### DETAILED DESCRIPTION OF ILLUSTRATIVE. NON-LIMITING EMBODIMENTS OF THE PRESENT INVENTION

Hereinafter, a wearable finger motion sensor for sensing finger motions and a method of sensing the finger motions in accordance with exemplary embodiments of the present invention will be described more fully with reference to the accompanying drawings. The shapes of elements in the drawings are exaggerated for clarity. To facilitate understanding, identical reference numerals have been used, where possible, to designate identical elements that are common to the figures.

First, a wearable finger motion sensor for sensing finger motions according to the present invention will be described.

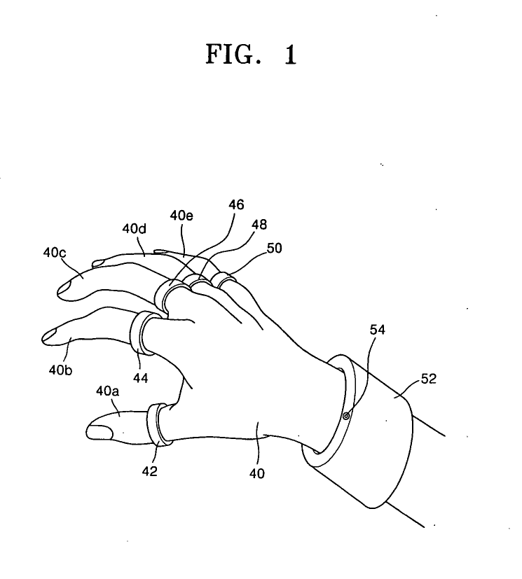

Referring to FIG. 1, wearable finger motion sensors for sensing motion of fingers according to a first exemplary embodiment of the present invention comprises first through fifth rings 42, 44, 46, 48, and 50 to be worn on a thumb 40a, an index finger 40b, a middle finger 40c, a ring finger 40d, and a little finger 40e, respectively, and a first bracelet 52. In the first bracelet 52, an image signal processing section (not shown) and a wireless communication module (not shown) are built-in. Also, a visual sensor 54 is disposed on a face of the first bracelet 52 facing toward the first through fifth rings 42, 44, 46, 48, and 50. The wireless communication module transmits final input data abstracted from the image signal processing section corresponding to the motion of the thumb 40a, index finger 40b, middle finger 40c, ring finger 40d, and little finger 40e to an external peripheral device, such as a computer. An antenna for transmitting the final input data to the external device is built in the wireless communication module. The antenna can be disposed outside of the wireless communication module, i.e., the first bracelet 52. The image signal processing section processes images of the fingers through the visual sensor 54, and transmits data to the wireless communication module after abstracting data corresponding to the moved fingers. The visual sensor 54, which is a means for sensing movement of the thumb 40a, index finger 40b, middle finger 40c, ring finger 40d, and little finger 40e, is a mini camera having wide angle capability when taking stationary or motion pictures. The pictures taken (sensed images) by the visual sensor 54 are transmitted to the image processing section so that data corresponding to the motion of the fingers can be abstracted.

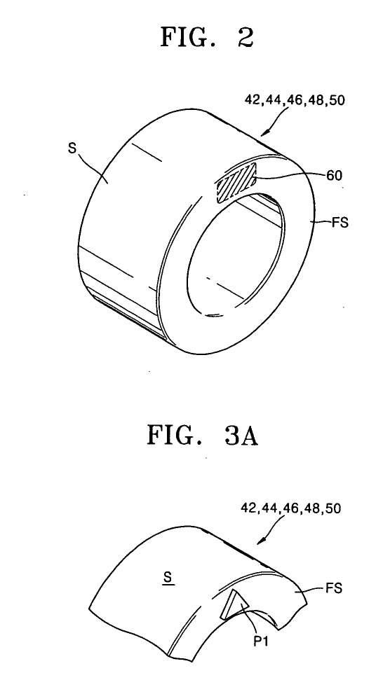

Referring to FIG. 2 which is a magnified image of the first through fifth rings 42, 44, 46, 48, and 50, a pattern forming region 60 is defined on the front face FS of each ring facing the first bracelet 52. A predetermined form of recognition pattern for sensing finger motions, that is, for identifying each ring, is formed on the pattern forming region 60. Preferably, the first through fifth rings 42, 44, 46, 48, and 50 have the same shape. However, it is preferable that the recognition pattern formed on the pattern forming region 60 on each ring is different.

When a finger is moved while all of the fingers are being sensed by the visual sensor 54, an image of a specific recognition pattern of the moved ring instantly disappears then reappears. As a result, the motion of the ring is readily sensed since a different recognition pattern is formed on each pattern forming region 60 of each ring worn on each finger. Then, the image signal processing section abstracts which recognition pattern is moved from the analysis of the image transmitted from the visual sensor 54 by referring to the characteristic of each pattern, i.e., size, shape, and color. Afterward, input data corresponding to the moved finger is transmitted to the wireless communication module.

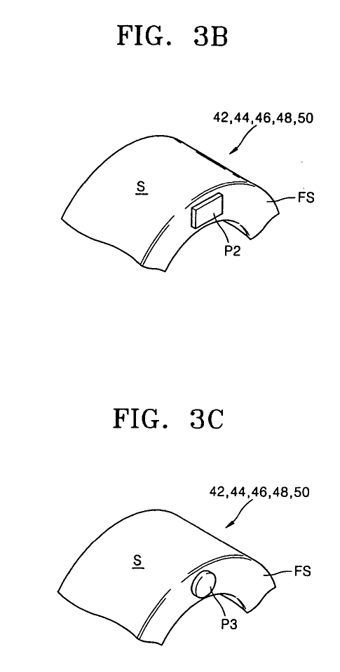

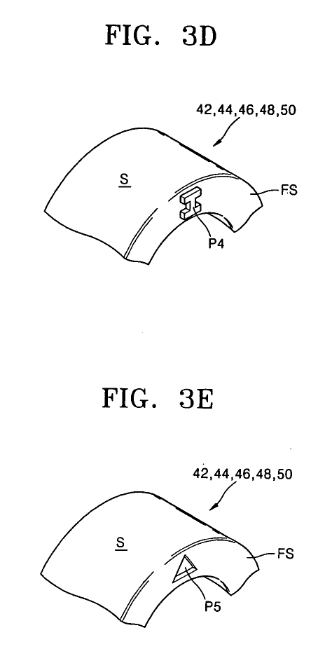

Referring to FIG. 3A, a first pattern P1, as a recognition pattern, can be formed on the pattern forming region 60 on each ring. The first pattern P1 is an embossed triangle.

Referring to FIG. 3B, a second pattern P2, as a recognition pattern, can be formed on the pattern forming region 60 on each ring. The second pattern P2 is an embossed square.

Referring to FIGS. 3C and 3D, third and fourth patterns P3 and P4, as recognition patterns, can be formed on the pattern forming region 60 on each ring. The third pattern P3 is an embossed circle, and the fourth pattern P4 is an embossed Roman letter “l.”

Referring to FIG. 3E, fifth pattern P5, as a recognition pattern, that is different from the first through fourth patterns P1, P2, P3, and P4, can be formed on the pattern forming region 60 on each ring. The fifth pattern P5 is an engraved triangle.

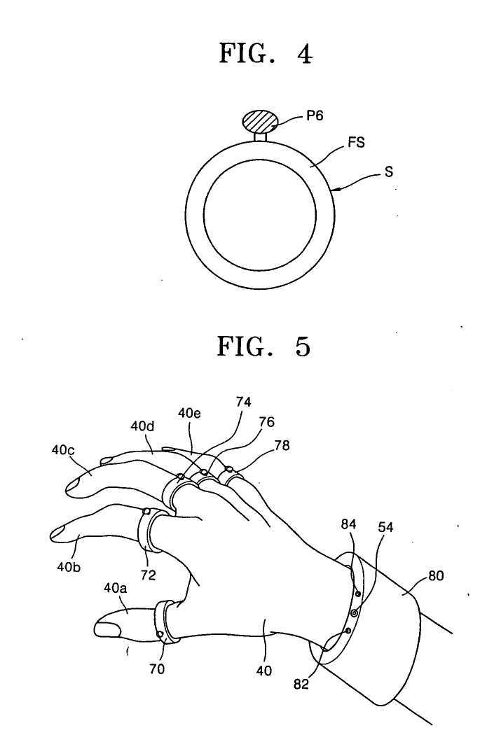

Instead of forming a recognition pattern on a pattern region 60 for each of the first through fifth rings 42, 44, 46, 48, and 50, a sixth pattern P6 having a predetermined shape on an upper surface of each ring can be formed as depicted in FIG. 4. The sixth pattern P6 is a circular formative statue. Preferably, the sixth pattern P6 formed on each of the first through fifth rings 42, 44, 46, 48, and 50 is a different formative statue for identification purposes.

A feature of a second exemplary embodiment is that the ring is equipped with an infrared reflection device and the bracelet has an infrared emission device.

The same numerals and symbols used in the first embodiment will be used for identical elements in the second exemplary embodiment.

Referring to FIG. 5, a wearable finger motion sensor according to the second exemplary embodiment of the present invention comprises sixth through tenth rings 70, 72, 74, 76, and 78 to be worn on the thumb 40a, index finger 40b, middle finger 40c, ring finger 40d, and little finger 40e, respectively, and a second bracelet 80 to be worn on the wrist. A visual sensor 54 and first and second infrared emission devices 82 and 84 are disposed on a face of the second bracelet 80 so as to face toward the sixth through tenth rings 70, 72, 74, 76, and 78. Preferably, the first and second infrared emission devices 82 and 84 are light emitting diodes (LED). Discharged infrared light from the first and second infrared emission devices 82 and 84 are input to the visual sensor 54 after reflecting off of the sixth through tenth rings 70, 72, 74, 76, and 78. In order to increase the receiving efficiency of the reflected infrared light from the sixth through tenth ring 70, 72, 74, 76, and 78, an infrared filter (not shown) having a relatively high transmission rate can be mounted on the front surface of the visual sensor 54. Preferably, the sixth through tenth rings 70, 72, 74, 76, and 78 are all identical.

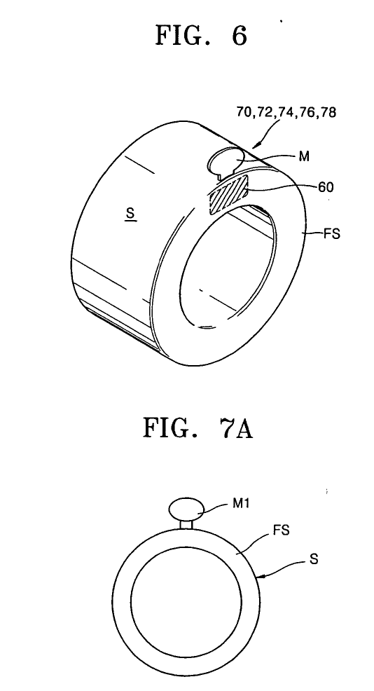

Referring to FIG. 6 which is a magnified view of the sixth through tenth rings 70, 72, 74, 76, and 78, a reflection device M can be provided on each ring in order to reflect the infrared light emitted from the first and second infrared emission devices 82 and 84. The reflection device M, as a reflection mirror, can be disposed on an upper face S of each of the sixth through tenth rings 70, 72, 74, 76, and 78. The reflection device M is disposed on the upper face S of each ring in FIG. 6, but they can be disposed at other portions, such as on a center or end portion of the upper face S.

Having the first and second infrared emission devices 82 and 84 on the second bracelet 80 and the infrared reflection device M on each of the sixth through tenth rings 70, 72, 74, 76, and 78, the motion of the fingers can be easily sensed even in a dark environment which ordinarily makes it difficult to identify the recognition pattern formed on the pattern forming region 60.

The reflection device M can not only reflect infrared light but can also act as a recognition pattern. That is, when the reflection device M of each ring has a different shape, the reflection device M of each ring can be used as the reflection device for reflecting the infrared light and as the recognition pattern for sensing the finger motions. In this case, the pattern forming region 60 for the sixth through tenth rings 70, 72, 74, 76, and 78 is unnecessary.

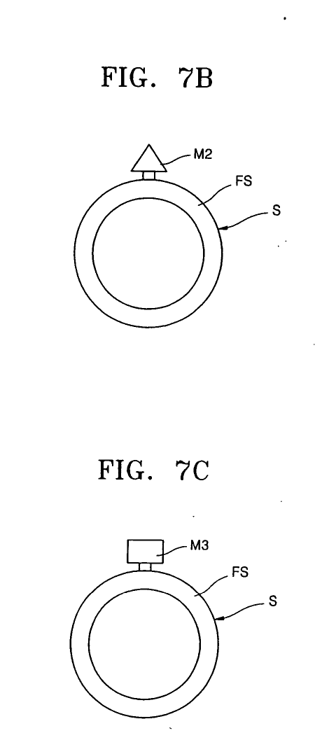

FIGS. 7A through 7C are examples of reflection devices M. In the case of the rings shown in FIGS. 7A through 7C, the pattern forming region 60 mentioned earlier does not exist on the front face S.

Referring to FIG. 7A, a first multi-function pattern M1, which performs as the infrared reflection device and the recognition pattern is disposed on the upper surface S of the ring. The first multi-function pattern M1 which faces toward the second bracelet 80 is geometrically circular, and is a formative statue functioning as a reflection mirror for reflecting the infrared light.

Referring to FIG. 7B, a second multi-function pattern M2, which performs the same functions as the ring in FIG. 7A, is disposed on the upper surface S of the ring. The second multi-function pattern M2, which faces toward the second bracelet 80, is a geometrically triangle shape, and is a formative statue functioning as a reflection mirror for reflecting the infrared light.

Referring to FIG. 7C, a third multi-function pattern M3 is disposed on the upper surface S of the ring. The third multi-function pattern M3 is also a formative statue, the same as the first and the second multi-function patterns M1 and M2, but has a face that faces toward the second bracelet 80 having a geometrically square shape.

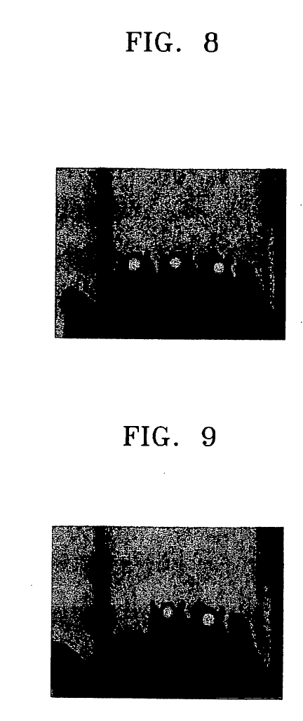

FIGS. 8 through 11 are photographed images of fingers taken by the visual sensor 54 equipped on a wearable finger motion sensor according to the first and second embodiment of the present invention. The images are taken while demonstrating motions of the index finger, middle finger, and ring finger of the right hand wearing the wearable finger motion sensor. Bright spots in the picture are the infrared reflection mirrors.

As shown in FIG. 8, the three rings worn on the index finger, middle finger, and ring finger are all showing. In this case, the image signal processing section does not transmit any signal to the wireless communication module because the sensor recognizes that there is no motion of the fingers. Accordingly, no data is transmitted from the bracelet to the peripheral devices.

However, as shown in FIG. 9, the ring on the index finger is not visible in the image or the infrared light is not reflected from the ring on the index finger, and the image processing section recognizes the motion of the index finger through image analysis. Accordingly, the image processing section transmits data corresponding to the motion of the index finger to the wireless communication module, and then the wireless communication module transmits the received data from the image processing section to the peripheral devices.

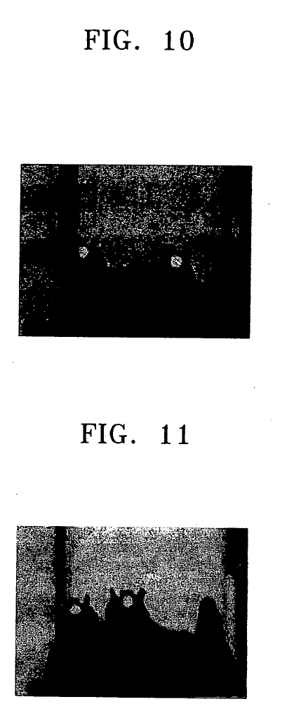

As shown in FIGS. 10 and 11, when the rings on the middle finger and ring finger are not visible in the image, only the input data transmitted from the image processing section to the wireless communication module is different, the rest of the data that is processed is with the same method as in the case in FIG. 9.

Next, a method of sensing finger motions using the wearable finger motion sensor according to the present invention will be described.

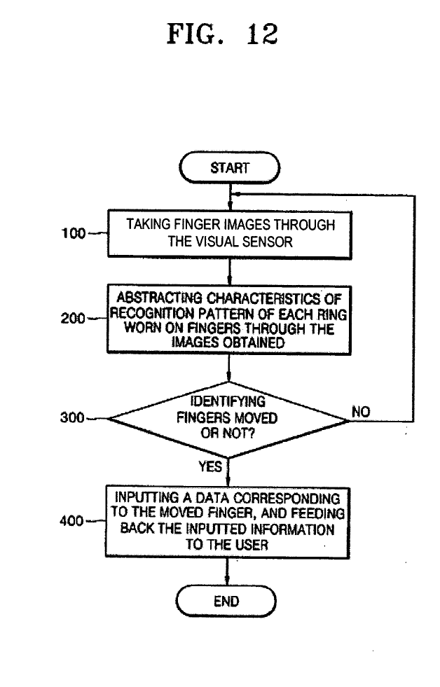

Referring to FIG. 12, a first step 100 is a step for acquiring the finger image via the visual sensor. At this time, it is preferable to use a wide angle mini camera capable of taking stationary or motion pictures of all five fingers at the same time.

A second step 200 is a step for abstracting characteristics of each ring worn on the fingers through the images obtained by the visual sensor. More specifically, in order to abstract the characteristics of each ring from the images obtained, image analysis is conducted by the image processing section. This analysis is conducted by using a binary scale technique and a template matching technique. Through the above analysis, the characteristics of each ring, such as the color, size, or shape of the recognition pattern patterned on the pattern forming region 60 in FIGS. 1 and 5 can be recognized.

When the sensor is the sensor according to the second embodiment of the present invention as depicted in FIG. 5, the characteristics of the infrared reflection of the ring is abstracted in the second step 200. That is, a ring that reflects infrared light and a ring that does not reflect infrared light are abstracted.

More specifically, from the images obtained through the visual sensor, binary scale images including those of the reflection device M in FIG. 6, M1 in FIG. 7A, M2 in FIG. 7B, and M3 in FIG. 7C that are brightly spotted by the reflection of the infrared light are abstracted. Afterward, the reflection device is abstracted through an image filter in which the information of the reflection device such as the size and shape are programmed. Location information of the abstracted reflection device can be obtained through a center of gravity method.

A third step 300 is a step for identifying whether the fingers moved. More specifically, the movement of a finger can be identified based on the data obtained in the second step 200. When abstracted data of a particular ring is not found in the abstracted data or no infrared light is reflected from the ring on the particular finger, the image processing section recognizes the finger of the particular ring that has moved (Yes). When that is not the case, the image processing section recognizes the finger to have not moved (No).

In the former case, the step proceeds to a fourth step 400, but in the latter case, the step returns to the first step 100.

The fourth step 400 is a step for inputting data corresponding to the moved finger, and providing the input information to the user.

More specifically, according to the identification result from the third step 300, when a finger has moved, the image processing section built in the bracelet transmits information (input data) on the corresponding finger to the wireless communication module built in the bracelet, and the wireless communication module transmits the received information to the peripheral devices through wireless communication. At this time, the information transmitted to the peripheral devices can be displayed on a monitor so that the user can see.

As shown in the foregoing descriptions, the wearable finger motion sensor according to the embodiment of the present invention is equipped with a wrist bracelet having a built in visual sensor, an image processing section, and wireless communication module, and finger rings having a recognition pattern or an infrared reflection mirror for identifying each ring, and does not include separate conventional devices for sensing. The wearable finger motion sensor according to the present invention is similar to an ordinary ring. Therefore, it has advantages in that it can be worn and removed easily, and can be worn comfortably. Also, since it can be minimized in size and consume less power, a small battery and a small antenna can be built in the wearable finger motion sensor, thereby forming a simplified structure.

While this invention has been particularly shown and described with reference to exemplary embodiments thereof, it should not be construed as being limited to the embodiments set forth herein. This invention may, however, be embodied in many different forms by those skilled in the art. For example, instead of providing a recognition pattern on each ring, the shape of each ring on each finger can be formed in different form as a recognition pattern. Also, instead of separately providing an infrared reflection device on each ring, the face of the ring facing the bracelet can be formed as an infrared reflection face. Likewise, since the present invention can be made in many different forms, the scope of the present invention shall be defined by the spirit of and scope of the appended claims, and not by the embodiments set forth herein.

What is claimed is:

1. A wearable finger motion sensor comprising:
a ring on which a predetermined recognition pattern is formed, the ring to be worn on a finger;
a bracelet comprising a photographing tool for taking pictures of the finger having the ring thereon; and
an image processing section to recognize a moved finger by analyzing the images photographed by the photographing tool and abstracting data corresponding to the moved finger.

2. The wearable finger motion sensor of claim 1, further comprising a wireless communication module having an antenna, being one of built-in and external, for transmitting data abstracted on the bracelet.

3. The wearable finger motion sensor of claim 1, wherein the bracelet comprises first and second infrared light emission devices disposed on both sides of the photographing tool to emit infrared light toward the ring.

4. The wearable finger motion sensor of claim 1, wherein a ring is provided for each of five fingers of a hand, respectively, and the photographing tool is a wide angle mini camera capable of taking pictures of the five fingers simultaneously.

5. The wearable finger motion sensor of claim 1, wherein a ring is provided for at least two fingers, respectively, and each recognition pattern of each ring has a different shape that is an embossed or engraved pattern, formed on a face of each ring facing the bracelet.

6. The wearable finger motion sensor of claim 1, wherein the recognition pattern is a formative statue having a predetermined shape different from a recognition pattern formed on a ring for a different finger, so that each finger has a unique recognition pattern.

7. The wearable finger motion sensor of claim 3, wherein an infrared light filter is disposed on a front face of the photographing tool.

8. The wearable finger motion sensor of claim 5, wherein an infrared light reflection mirror is disposed on an upper surface of each of said rings.

9. The wearable finger motion sensor of claim 6, wherein the formative statue is an infrared light reflection mirror.

10. The wearable finger motion sensor of claim 2, wherein first and second infrared light emission devices are disposed on both sides of the photographing tool.

11. A method of sensing finger motions comprising:
taking pictures of fingers each wearing a ring on which a predetermined recognition pattern is formed;
abstracting a characteristic of the recognition pattern of each of the rings worn on the fingers through an analysis of the picture of the finger; and
identifying existence of movement of a finger based on the abstracted characteristics.

12. The method of claim 11 further comprising transmitting data corresponding to a moved finger, upon identification of the moved finger, to an external device.

13. The method of claim 11, wherein the step of taking pictures of the fingers is performed when infrared light is irradiated to the rings.

14. The method of claim 13, wherein abstracting a characteristic of the recognition pattern of the ring worn on the finger through an analysis of the finger further comprises:
obtaining a binary scale image which includes a bright spot in an image of the finger by irradiating infrared light;
identifying the bright spot using an image filter in which information on size and shape of the bright spot are programmed;
obtaining a location of the identified bright spot.

15. The method of claim 12, wherein the data is simultaneously transmitted to an external device and provided to a user.
